(19) United States
(12) Patent Application Publication
(10) Pub. No.: US 2020/0204901 A1
(43) Pub. Date: Jun. 25, 2020

(54) Adjustable Headphone Neck Band

(71) Applicant: Plantronics, Inc., Santa Cruz, CA (US)

(72) Inventors: Bowman Wang, Ben Lomond, CA (US); Terry M. Carr, Santa Cruz, CA (US); Jeremy Jacob D'Ambrosio, Soquel, CA (US)

(73) Assignee: Plantronics, Inc., Santa Cruz, CA (US)

(21) Appl. No.: 16/230,761

(22) Filed: Dec. 21, 2018

(51) Int. Cl. H04R 1/10

(52) U.S. Cl. CPC H04R 1/1066; H04R 2460/13; H04R 1/105

(57) ABSTRACT

Bone conduction headphones include a transducer and a neck band. The transducer is configured to convert an electrically provided audio signal into mechanical vibrations. The neck band includes a curved base section and two leg sections extending from the curved base section, providing a substantially U-shaped space to accommodate a listener's head between the two leg sections. The transducer is disposed on the neck band at a distal end of one of the leg sections, and the neck band applies a clamping force on the listener's head. The clamping force establishes a mechanical interface for transmission of the mechanical vibrations from the transducer to a cranial bone of the listener's head. The bone conduction headphones also include a clamping force adjuster enabling an adjustment of the clamping force of the neck band.

### BACKGROUND

Bone conduction may be used for the transmission of sound through the cranial bones of the skull. A transducer of bone conduction headphones may generate mechanical vibrations that are transmitted to the internal ear of a listener by the cranial bones. Good mechanical contact of the transducer with the cranial bones and through tissue improves the quality of the sound transmission. Accordingly, headphones may apply a certain level of a clamping force to press the transducers against the skull.

### SUMMARY

In general, in one aspect, one or more embodiments relate to bone conduction headphones. The bone conduction headphones include a transducer configured to convert an electrically provided audio signal into mechanical vibrations, a neck band including a curved base section and two leg sections extending from the curved base section, providing a substantially U-shaped space to accommodate a listener's head between the two leg sections. The transducer is disposed on the neck band at a distal end of one of the leg sections, and the neck band applies a clamping force on the listener's head, the clamping force establishing a mechanical interface for transmission of the mechanical vibrations from the transducer to a cranial bone of the listener's head. The bone conduction headphones further include a clamping force adjuster enabling an adjustment of the clamping force of the neck band.

In general, in one aspect, one or more embodiments relate to a clamping force adjuster for bone conduction headphones. The clamping force adjuster includes a removable stiffening brace installable on a neck band of the bone conduction headphones to increase a clamping force applied on a listener's head by the neck band.

In general, in one aspect, one or more embodiments relate to a method for adjusting a fit of bone conduction headphones. The method includes receiving, from a listener and by a clamping force adjuster of the bone conduction headphones, an adjustment input, and based on the adjustment input, adjusting spring-like characteristics of a neckband of the bone conduction headphones to modulate a clamping force of the neck band. The neck band establishes a substantially U-shaped space to accommodate a head of the listener, the neck band applying the clamping force to the head to establish a mechanical interface for transmission of mechanical vibrations from a transducer of the bone conduction headphones to a cranial bone of the head.

Other aspects of the disclosure will be apparent from the following description and the appended claims.

### BRIEF DESCRIPTION OF DRAWINGS

FIGS. 1 and 2 show bone conduction headphones in accordance with one or more embodiments of the invention.

FIGS. 3A, 3B, and 3C show bone conduction headphones in accordance with one or more embodiments of the invention.

FIGS. 4A and 4B show bone conduction headphones in accordance with one or more embodiments of the invention.

FIGS. 5A, 5B, and 5C show bone conduction headphones in accordance with one or more embodiments of the invention.

FIGS. 6A, 6B, and 6C show bone conduction headphones in accordance with one or more embodiments of the invention.

FIGS. 7A and 7B show bone conduction headphones in accordance with one or more embodiments of the invention.

FIG. 8 shows a flowchart describing a method for adjusting the fit of bone conduction headphones in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, although the description includes a discussion of various embodiments of the invention, the various disclosed embodiments may be combined in virtually any manner. All combinations are contemplated herein.

Bone conduction may be used for the transmission of audio signals, i.e. sound, via the cranial bones of the skull. A transducer of bone conduction headphones may generate mechanical vibrations that are transmitted to the internal ear of a listener via the cranial bones. Good mechanical contact of the transducer with the cranial bones may support the transmission of decent quality and/or amplitude audio. Good mechanical contact may be particularly desirable because tissue including skin and/or muscle between the transducer and the cranial bone may attenuate the mechanical vibrations to be transmitted.

One or more embodiments are directed to adjustable bone conduction headphones to apply a selectable level of clamping force to press the transducer(s) against the skull. The level of force selected may depend on multiple factors, such as the listener's comfort with the applied force, the need or desire for a particular amplitude and/or quality of the audio signal, and other such factors. For example, a listener may adjust the clamping force based on personal preferences and/or based on environmental conditions. A listener may prefer a tighter fit of the bone conduction headphones when requiring particularly good audio quality, and/or when performing activities that could result in movement of the headphones, such as while physically exercising. On the other hand, in a static, quiet environment, the listener may prefer a looser fit for comfort. In one or more embodiments of the invention, a neck band of the bone conduction headphones is adjustable to enable a listener to vary the clamping force applied to the listener's head by the headphones.

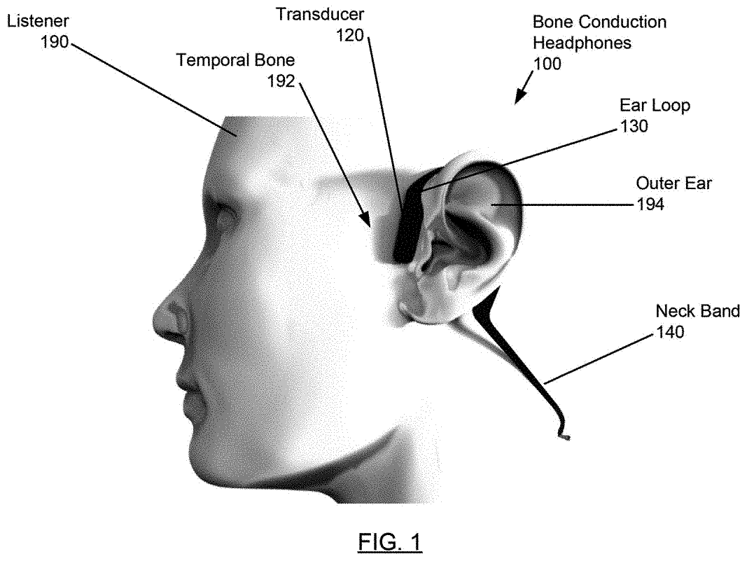

Turning to FIG. 1, a side view of a portion of bone conduction headphones (100), in accordance with one or more embodiments, are shown. The bone conduction headphones (100) may be worn by a listener (190) as shown in FIG. 1. The bone conduction headphones (100) may include one or more transducers (120), ear loops (130), and a neck band (140). Each of these components is subsequently described.

The transducer(s) (120) is an actuator that translates audio signals provided as an input signal, such as speech or music, into mechanical vibrations. For example, the transducer may be an electromechanical or piezoelectric actuator, or any other type of actuator capable of translating electrically provided audio signals into mechanical vibrations. The transducer may be placed on the surface of the temporal bone (192) of the listener (190), in front of the ear, as illustrated in FIG. 1. A left and a right transducer may be used for binaural audio signals. Additional transducers may further be used. For example, additional transducers may be placed behind the ears. The transducers (120) are held in position by the neck band (140) and may receive further support by the ear loops (130), in accordance with one or more embodiments of the invention, as illustrated in detail in the subsequent figures. To obtain a reliable transmission of the mechanical vibrations from the transducer (120) to the temporal bone (192), the transducer (120) may need to be pressed against the head of the listener (190) with at least a minimum force. If the applied force is insufficient, the mechanical vibrations, which may be attenuated by skin and muscle tissue between the transducer and the temporal bone, may not reach the inner ear where the mechanical vibrations are translated into a perceivable audio signal. Alternatively, as a result of insufficient force being applied, only a limited frequency band may be transmitted, thereby resulting in a poor audio signal obtained by the inner ear. In one or more embodiments of the invention, an adjustable force is provided by the neck band (140), as further discussed below.

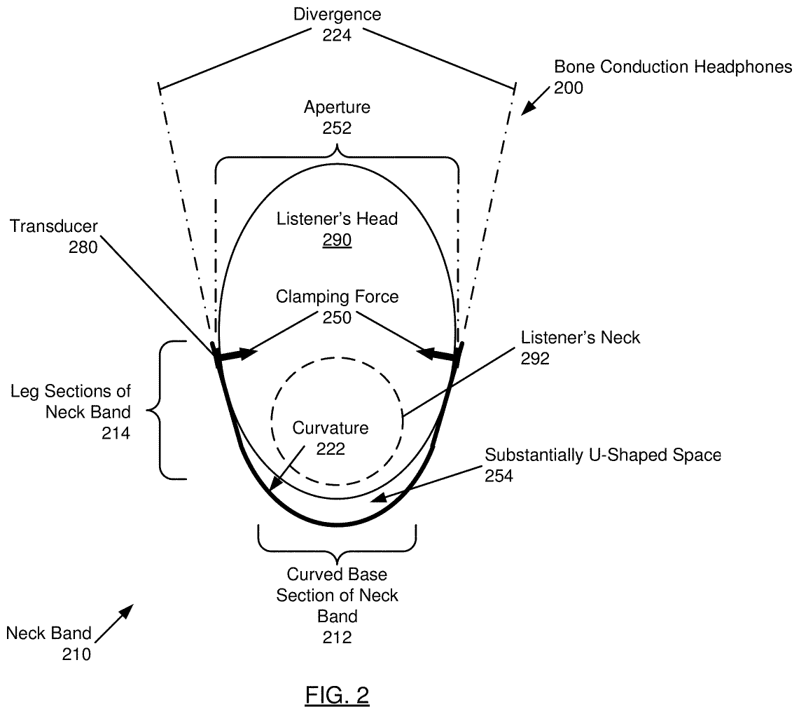

The neck band (140), in accordance with one or more embodiments of the invention, forms a clamp surrounding the listener's head, as discussed in detail below with reference to FIG. 2. The neck band (140) may, thus, provide a clamping force pressing the transducer(s) (120) against the listener's head, for example, in proximity to the temporal bone (192). The neck band (140) is adjustable to enable the listener to vary the clamping force as desired. The neck band (140) may include ear loops (130) to position and stabilize the bone conduction headphones (100) on the listener's (190) head by at least partially wrapping around the outer ears (194).

Turning to FIG. 2, a top down view of bone conduction headphones (200), in accordance with one or more embodiments of the invention, are shown. The bone conduction headphones (200) include a neck band (210), disposed on a listener's head (290). The neck band (210) may include a curved base section (212). The curved base section (212) may wrap around the neck (292) of the listener's head (290). As illustrated in FIG. 2, two leg sections (214) of the neck band extend from the curved base section (212) of the neck band. In combination with the curved base section (212), the two leg sections (214) may form a U-shape with an aperture (252). Transducers (280) may be installed at or near the distal ends of the leg sections (214).

A clamping force (250) may be provided by the neck band (214) to press the transducers (280) against the listener's head (290). The clamping force (250) may be a result of the neck band (210) or one or more sections of the neck band having spring-like characteristics. As shown in FIG. 2, the curved base section (212) may have a curvature (222). Further, the leg sections (214) may also have a slight curvature, although shown as straight, in FIG. 2. The curvature may be selected such that a space between the two leg sections, establishing the aperture (252), is narrower than the width of the listener's head (290) in the neutral state. The neutral state is when the listener's head is not present. Accordingly, the neck band (210) is bent outward, thereby widening the space between the two leg sections (214), to accommodate the listener's head by the aperture (252) when the listener dons the headphones. As a result of the outward bending, and due to the spring-like characteristics of the neck band (210), the clamping force (250) may be generated.

Assume, for example, that in a neutral state, the leg sections (214) of the neck band are parallel, such that the leg sections have zero divergence. To put on the headphones, the leg sections (214) would be bent outward, thus increasing the divergence (224) of the leg sections, and thereby producing the clamping force (250). Different clamping forces may be generated by adjusting the divergence (224) of the leg sections (214) of the neck band (210) in the neutral state. If the leg sections (214) are diverging outward in the neutral state, rather than being parallel, less outward bending of the leg sections is necessary to accommodate the listener's head, thus reducing the clamping force (250). In contrast, to obtain an increased clamping force (250), the divergence (224) of the leg sections (224) may be negative with the leg sections (214) point inward, when in the neutral state. Additionally, or alternatively, the stiffness of the neck band (210) may be varied. A neck band (210) with a higher stiffness may produce a higher clamping force (250) than a neck band with a lower stiffness.

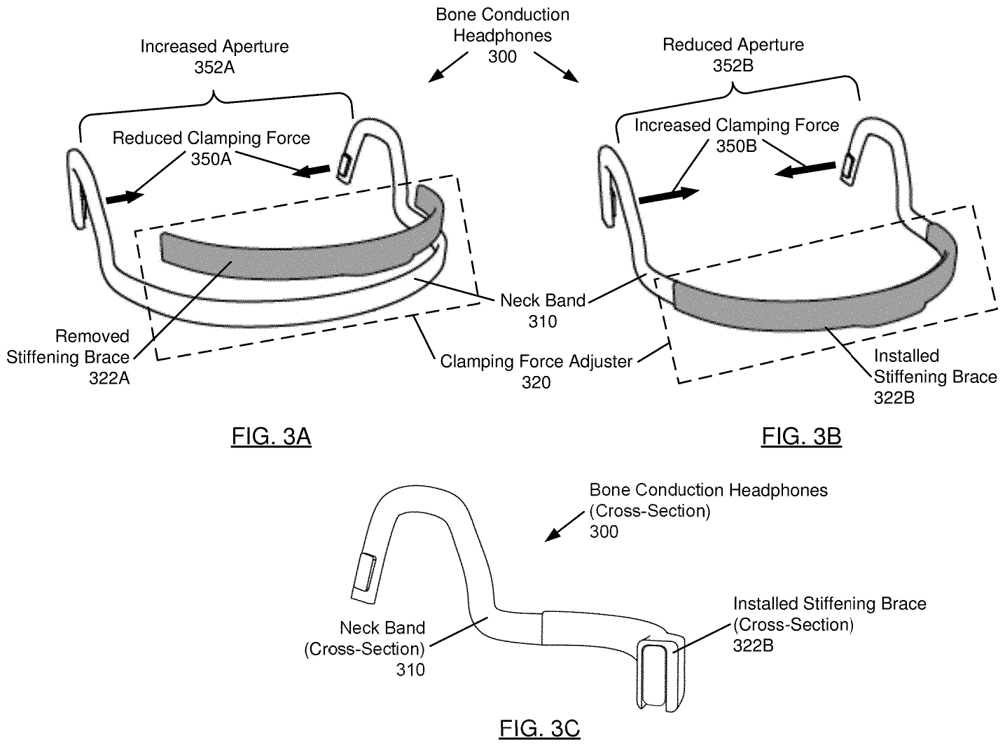

The bone conduction headphones (200) includes a clamping force adjuster (not shown) that is configured to provide a selectable level of clamping force. The clamping force adjuster enables an adjustment of the clamping force of the neck band. Specifically, in one or more embodiments, the clamping force adjuster is a mechanical device that is configured to mechanically change the clamping force in response to user action. Example clamping force adjusters are described below with reference to FIGS. 3A-3C, 4A, 4B, 5A-5C, 6A, 6B, 7A and 7B.

While the neck band (210) is described as U-shaped, those skilled in the art having benefit of the disclosure will appreciate that deviations from a U-shape are possible without departing from the invention. For example, as shown in FIG. 1, the U-shaped neck band may include ear loops. The neck band, as illustrated in FIG. 2 may be implemented in various ways. FIGS. 3A-3C, 4A, 4B, 5A-5C, 6A, 6B, 7A and 7B show various embodiments of a neck band, in accordance with one or more embodiments of the invention.

Various materials may be used for the neck band. In one or more embodiments of the invention, materials that are flexible are used, for example certain polymer, metals, and/or composite materials, including fiberglass.

Turning to FIGS. 3A, 3B, and 3C bone conduction headphones (300), in accordance with one or more embodiments of the invention, are shown. FIG. 3A shows the bone conduction headphones in a configuration that produces a reduced clamping force (350A), whereas FIG. 3B shows the bone conduction headphones in a configuration that produces an increased clamping force (350B). FIG. 3C shows a cross section of elements of the bone conduction headphones (300).

The bone conduction headphones (300) include a neck band (310). The structure of the neck band (310) may be substantially similar to the configuration discussed with reference to FIG. 2. In other words, the neck band (310) may be substantially U-shaped and may include a curved base section and two leg sections (see FIG. 2 for a description of the curved base section and the leg sections). In one or more embodiments, at least a part of the neck band (310) has spring-like characteristics, thus producing a clamping force (350A, 350B) when worn by a listener. Specifically, at least part of the neck band (310) includes an elastic material that recovers a neutral shape when released, such as when not worn by the listener or otherwise experiencing a force. The neck band may be made of a polymer, fiberglass, etc. Alternatively, the neck band may be made of a composite material, for example, a metal core enclosed by an overmold polymer.

In one or more embodiments of the invention, the headphones (300) include a clamping force adjuster (320), enabling the listener to adjust the clamping force (350A, 350B) by modulating the spring-like characteristics of the neck band (310). The clamping force adjuster (320), in one embodiment of the invention, includes a stiffening brace (322A, 322B). The stiffening brace (322A, 322B) is a component that may be installed on top of the neck band (310) to increase the clamping force. The clamping force may be increased by (i) increasing the curvature of the neck band (see FIG. 2 for a discussion of the curvature of the neck band); (ii) increasing the stiffness of the neck band; or (iii) a combination of (i) and (ii). (i), (ii) and (iii) may be accomplished by installation of the stiffening brace (322B).

The stiffening brace may be designed with a curvature that is substantially similar to the curvature of the neck band before a listener dons the headphones. Such a stiffening brace would provide additional stiffness to the neck band (310). Additionally, or alternatively, the stiffening brace may be over-curved, with a curvature exceeding the curvature of the neck band. Such a stiffening brace would not only provide additional stiffness to the neck band, but would also increase the curvature of the neck band, thereby producing an additional clamping force when donned by the listener. The effect of the stiffening brace may further be modulated based on the length of the stiffening brace. While a relatively long stiffening brace, covering most of the neck band, is shown in FIGS. 3A and 3B, shorter segments of a stiffening brace may be used to obtain a smaller increase of the clamping force. The amount of the additionally provided clamping force may, thus, depend on the length of the stiffening brace, the curvature of the stiffening brace, and the stiffness of the stiffening brace.

Various designs of the stiffening brace may produce the additional clamping force. For example, a stiffening brace with a U-shaped cross section as shown in FIG. 3C, may be slid on top of the neck band. Such a stiffening brace, when installed, would cover both inner and outer surfaces of the U-shape formed by the neck band. The U-shaped cross section of the stiffening brace may be slightly inward-tapered (with the U-narrowing toward the opening) and/or the U-shaped cross section of the stiffening brace may be equipped with lips to clip around the neck band to prevent unintentional detachment of the stiffening brace from the neck band. Alternative designs of the stiffening brace may cover only the inner surface of the U-shape formed by the neck band or only the outer surface of the U-shape formed by the neck band.

Bone conduction headphones (300) may be provided to a listener with one or more of the above described stiffening braces. Different stiffening braces may have different mechanical characteristics. The listener may, thus, select one of the stiffening braces to obtain the desired clamping force.

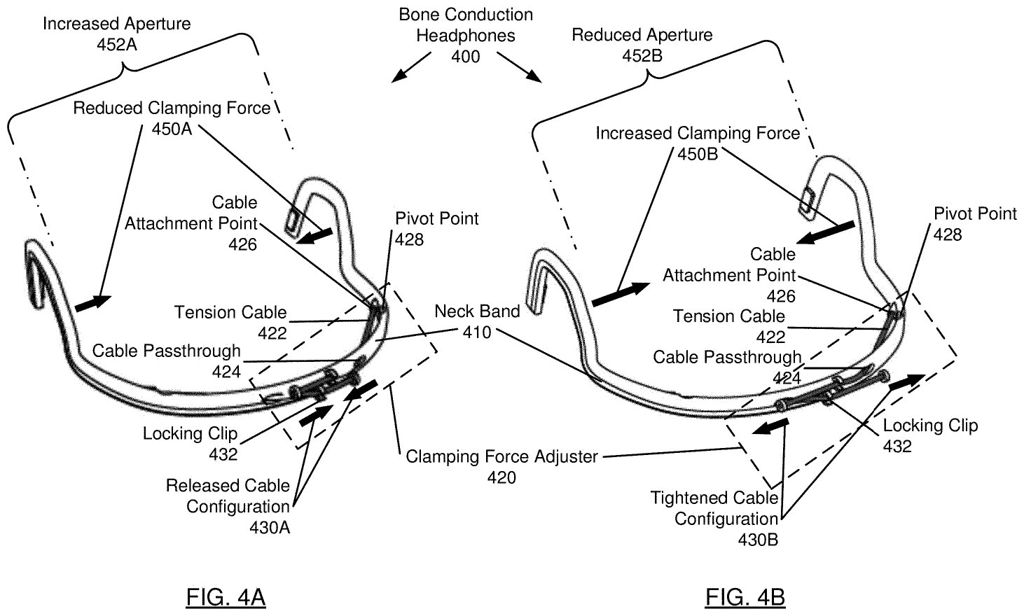

Turning to FIGS. 4A and 4B bone conduction headphones (400), in accordance with one or more embodiments of the invention, are shown. FIG. 4A shows the bone conduction headphones in a configuration that produces a reduced clamping force (450A), whereas FIG. 4B shows the bone conduction headphones in a configuration that produces an increased clamping force (450B).

The bone conduction headphones (400) include a neck band (410). The structure of the neck band (410) may be substantially similar to the configuration discussed with reference to FIG. 2. In other words, the neck band (410) may be substantially U-shaped and may include a curved base section and two leg sections (see FIG. 2 for a description of the curved base section and the leg sections). At least a part of the neck band (410), in accordance with one or more embodiments of the invention, has spring-like characteristics, thus producing a clamping force (450A, 450B), when worn by a listener. In one or more embodiments of the invention, the headphones (400) include a clamping force adjuster (420), enabling the listener to adjust the clamping force (450A, 450B). The clamping force adjuster (420) is based on a tension cable mechanism as subsequently described. In the configuration shown in FIGS. 4A and 4B, the main components of the clamping force adjuster (420) include the tension cable (422), the pivot point (428), and the locking clip (432).

In one or more embodiments of the invention, tension cables (422) are used to modulate the clamping force. A released cable configuration (430A) results in a reduced clamping force (450A), whereas a tightened cable configuration (430B) results in an increased clamping force (450B).

A first end of a tension cable (422), in accordance with an embodiment of the invention is attached to the neck band (410) at a cable attachment point (426). The cable attachment point may be placed on the interior of the U-shape of the neck band (410), as illustrated in FIGS. 4A and 4B. The tension cable may be a braided metal cable, a nylon, polyester or Kevlar cable, etc., and the cable attachment point may be a bonded or crimped connection between the tension cable and the neck band.

Tension on the tension cable (422) results in an inward flexion or increased curvature of the neck band (410), causing a decreased aperture (452B) of the U-shape of the headphones, thus reducing the space enclosed by the U-shape of the neck band (410). This may result in an increased clamping force (450B). Releasing the tension cable (422) may result in a return of the neck band to an initial state with a reduced curvature and increased aperture (452A). To facilitate the inward flexion, the neck band (410) may be equipped with pivot points (428). A pivot point may be a region of the neck band (410) with an increased flexibility. A pivot point (428) may be a result of a cutout in the neck band (410), with the resulting reduced thickness of the neck band (410) at the cutout causing the increased flexibility.

Tension on the tension cable (422) may be increased by the listener pulling on a second end of the tension cable (422). The tension cable (422) may be routed from the attachment point (426) on the interior of the U-shape of the neck band (410), via a cable passthrough (424) forming an opening in the neck band, to the exterior of the U-shape of the neck band (410), where the second end of the tension cable (422) may be accessible for operation in a central region of the neck band, as illustrated in FIGS. 4A and 4B. The neck band (410) may, thus, be tightened by pulling on the second end of the tension cable (422). The tension cable (422) may include features to facilitate pulling, such as a knot in the tension cable or a knob at the end of the tension cable. Two separate tension cables may be installed to operate both leg sections of the neck band, or alternatively a single tension cable may be installed. The single tension cable may connect to both attachment points (one on the left leg section of the neck band and one on the right leg section of the neck band), and the user may pull in a central region of the single tension cable to simultaneously apply tension on both sides of the neck band. If a single tension cable is used, the tension cable may form a loop at the back of the neck band, in the region of the curved base section of the U-shaped neck band. The loop may be grasped and pulled for tightening the neck band.

In one or more embodiments of the invention, locking clips (432) are provided to keep the tension cable (422) under tension, once tightened.

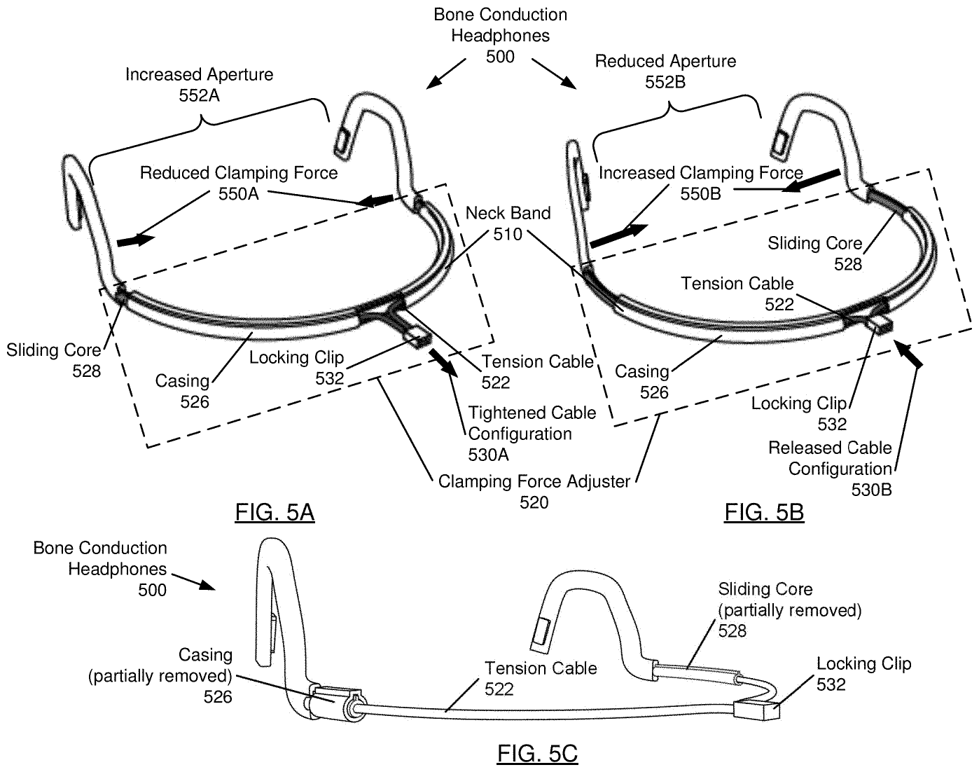

Turning to FIGS. 5A, 5B and 5C, bone conduction headphones (500), in accordance with one or more embodiments of the invention, are shown. FIG. 5A shows the bone conduction headphones in a configuration that produces a reduced clamping force (550A), whereas FIG. 5B shows the bone conduction headphones in a configuration that produces an increased clamping force (550B). In addition, FIG. 5C shows bone conduction headphones with various elements partially removed to provide additional details.

The bone conduction headphones (500) include a neck band (510). The structure of the neck band (510) may be substantially similar to the configuration discussed with reference to FIG. 2. In other words, the neck band (510) may be substantially U-shaped and may include a curved base section and two leg sections (see FIG. 2 for a description of the curved base section and the leg sections). At least a part of the neck band (510), in accordance with one or more embodiments of the invention, has spring-like characteristics, thus producing a clamping force (550A, 550B), when worn by a listener. In one or more embodiments of the invention, the headphones (500) include a clamping force adjuster (520), enabling the listener to adjust the clamping force (550A, 550B). In the configuration shown in FIGS. 5A and 5B, the main components of the clamping force adjuster (520) include the tension cable (522), the sliding core (528), the casing (626) and the locking clip (532). The clamping force adjuster (520), is subsequently described.

In one or more embodiments of the invention, neck band (510) includes a casing (526) and sliding cores (528) that may slidably engage with the casing (526) to varying degrees by sliding into and out of the casing (526), as illustrated in FIGS. 5A and 5B. The casing (526) may approximately correspond to the curved base section of the neck band (212) and the sliding cores (528) may approximately correspond to the leg sections (214), in FIG. 2. As illustrated in FIG. 5C, the sliding core (528) internally accommodates the tension cable (522). Further, the sliding core (528) is accommodated by the casing (526). To avoid rotation or the sliding core (528) relative to the casing (526), the sliding core may be equipped with a notch engaging with a groove in the casing, thereby enforcing alignment.

In one embodiment of the invention, the sliding cores (528) are curved. In

FIG. 5A, a configuration is shown, in which the curved sliding cores (528) are mostly or entirely housed by the casing (526), resulting in an increased aperture (552A) of the U-shape of the headphones. The space between the sliding cores (528) to accommodate the listener's head is therefore wide, resulting in a reduced clamping force (550A) when the headphones (500) are donned by the listener. In contrast, in FIG. 5B, a configuration is shown, in which the sliding cores (528) are only partially housed by the casing (526), resulting in a decreased aperture (552B) of the U-shape of the headphones. The reduced aperture (552B) may be a result of the sections of the sliding cores that are extending outside the casing (526) being curved toward the interior of the U-shape, as illustrated in FIG. 5B.

A tension cable (522) may be used to control the sliding of a sliding core (528) inside the casing (526). A first end of the tension cable (522) may be affixed to the sliding core (528), thus resulting in an inward movement of the sliding core (528), into the casing (526), when the tension cable (522) is pulled by the listener on a second end of the tension cable. Sliding of the core (528) out of the casing (526) may be achieved by the listener pulling the core out of the casing.

The tension cable (522) may be routed inside the sliding core and may exit the sliding core in a central region of the casing (526), as illustrated in FIGS. 5A and 5B. The tension cable (522) may include features to facilitate pulling, such as a knot in the tension cable or a knob at the end of the tension cable. Two separate tension cables may be installed to operate both sliding cores (528) of the neck band, or alternatively a single tension cable may be installed. The single tension cable may connect to both sliding cores (528), and the user may pull in a central region of the single tension cable to simultaneously apply tension on both sides of the neck band. If a single tension cable is used, the tension cable may form a loop at the back of the neck band in the region of the curved base section of the U-shaped neck band. The loop may be grasped and pulled for tightening the neck band.

In one or more embodiments of the invention, locking clips (532) are provided to keep the tension cable (522) under tension, once tightened.

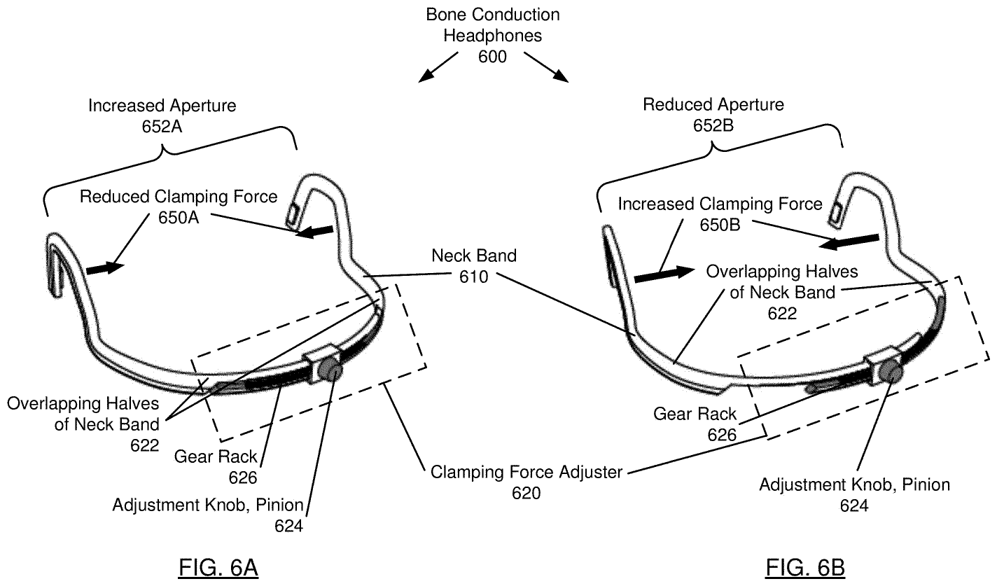

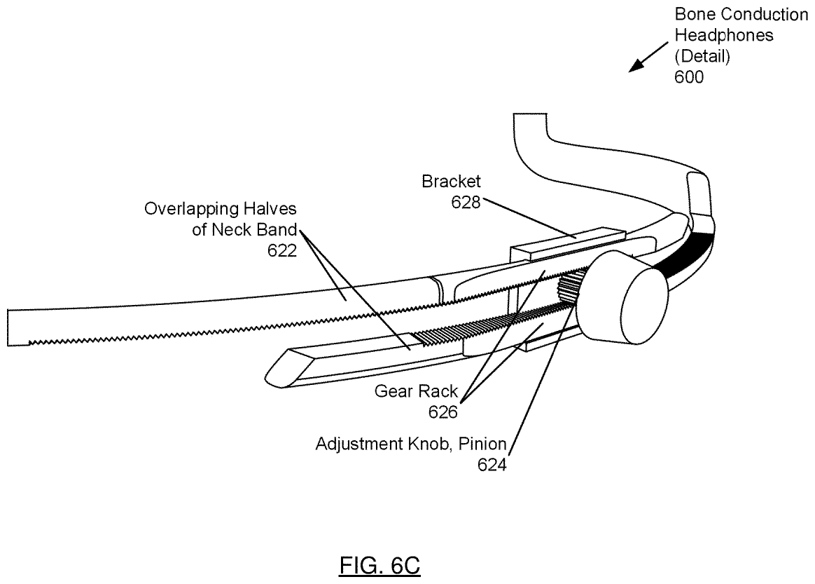

Turning to FIGS. 6A, 6B, and 6C, bone conduction headphones (600), in accordance with one or more embodiments of the invention, are shown. FIG. 6A shows the bone conduction headphones in a configuration that produces a reduced clamping force (650A), whereas FIG. 6B shows the bone conduction headphones in a configuration that produces an increased clamping force (650B). Further, FIG. 6C shows additional details of the bone conduction headphones.

The bone conduction headphones (600) include a neck band (610). The structure of the neck band (610) may be substantially similar to the configuration discussed with reference to FIG. 2. In other words, the neck band (610) may be substantially U-shaped. The neck band (610) may include two substantially mirror-symmetric overlapping halves that overlap at the curved base section ((212), in FIG. 2) of the U-shape provided by the neck band (610).

At least a part of the neck band (610), in accordance with one or more embodiments of the invention, has spring-like characteristics, thus producing a clamping force (650A, 650B), when worn by a listener. In one or more embodiments of the invention, the headphones (600) include a clamping force adjuster (620), enabling the listener to adjust the clamping force (650A, 650B). In the configuration shown in FIGS. 6A, 6B, and 6C the main components of the clamping force adjuster (620) include the overlapping halves (622) of the neck band, the gear rack (626), and the adjustment knob including the pinion (624). The clamping force adjuster (620) is subsequently described.

In one or more embodiments of the invention, the overlap of the halves (622) of the neck band is adjustable by the clamping force adjuster (620). More specifically, the clamping force adjuster (620) may include an adjustment knob driving a pinion (624), and the overlapping halves of the neck band (610), in the region of the overlap, may be equipped with gear racks (626). The pinion (624) may engage with the racks (626), such that turning the adjustment knob in one direction increases the overlap of the two overlapping halves (622) and turning the adjustment knob in the reverse direction reduces the overlap of the two overlapping halves. As illustrated in FIG. 6C, the gear racks (626) of the overlapping halves (622) and the pinion (624) are kept in alignment by a bracket (628).

In one embodiment of the invention, the overlapping halves (622) are curved. In FIG. 6A, a configuration is shown, in which the overlapping halves (622) have an increased overlap, causing in an increased aperture (652A) of the substantially U-shaped space accommodating the listener's head. The increased aperture (652A) results in a reduced clamping force (650A) when the headphones (600) are donned by the listener. In contrast, in FIG. 6B, a configuration is shown, in which the halves (622) have a reduced overlap, resulting in a decreased aperture (652B) of the substantially U-shaped space. The change of the aperture (652A, 652B) is a result of more or less overlap of the curved halves of the neck band.

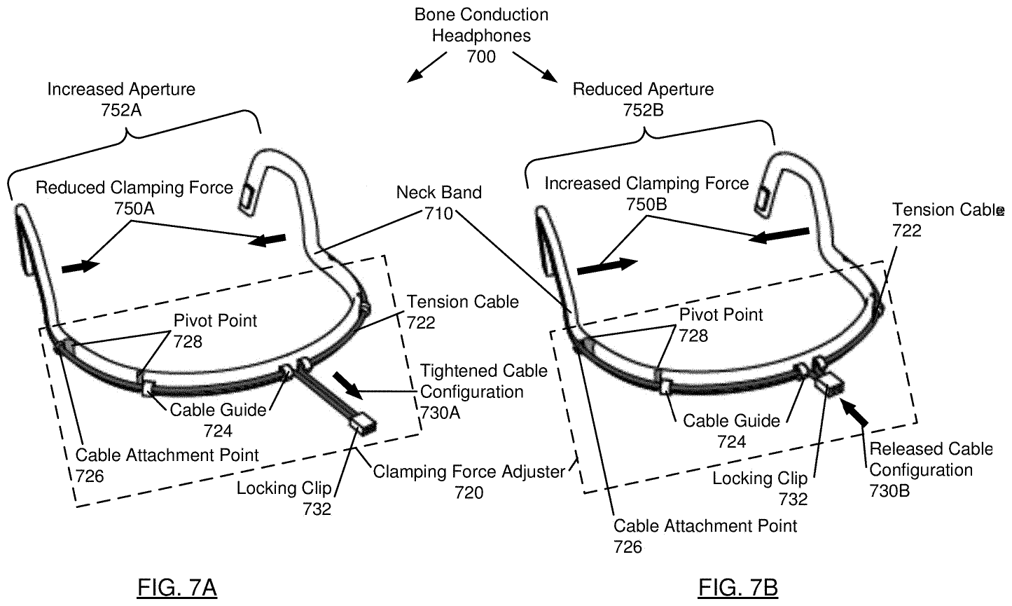

Turning to FIGS. 7A and 7B bone conduction headphones (700), in accordance with one or more embodiments of the invention, are shown. FIG. 7A shows the bone conduction headphones in a configuration that produces a reduced clamping force (750A), whereas FIG. 7B shows the bone conduction headphones in a configuration that produces an increased clamping force (750B).

The bone conduction headphones (700) include a neck band (710). The structure of the neck band (710) may be substantially similar to the configuration discussed with reference to FIG. 2. In other words, the neck band (710) may be substantially U-shaped and may include a curved base section and two leg sections (see FIG. 2 for a description of the curved base section and the leg sections). At least a part of the neck band (710), in accordance with one or more embodiments of the invention, has spring-like characteristics, thus producing a clamping force (750A, 750B), when worn by a listener. In one or more embodiments of the invention, the headphones (700) include a clamping force adjuster (720), enabling the listener to adjust the clamping force (750A, 750B). In the configuration shown in FIGS. 7A and 7B, the main components of the clamping force adjuster (720) include the tension cable (722), the pivot point (728), and the locking clip (732), as subsequently described.

In one or more embodiments of the invention, tension cables (722) are used to modulate the clamping force. A released cable configuration (730A) results in a reduced clamping force (750A), whereas a tightened cable configuration (730B) results in an increased clamping force (750B).

A first end of a tension cable (722), in accordance with an embodiment of the invention is attached to the neck band (710) at a cable attachment point (726). The cable attachment point may be placed on the exterior of the U-shape of the neck band (710), as illustrated in FIGS. 7A and 7B. Accordingly, tension on the tension cable (722) results in an outward flexion or reduced curvature of the neck band (710). The outward flexion or reduced curvature causes an increased aperture (752A), thus increasing the space enclosed by the U-shape of the neck band (710). Increasing the space may result in a reduced clamping force (750A). Releasing the tension cable (722) may cause the neck band (710) to return to an initial state with a reduced aperture (752B). To facilitate the outward flexion, the neck band (710) may be equipped with pivot points (728). A pivot point may be a region of the neck band (710) with an increased flexibility. A pivot point (728) may be a formed by a cutout in the neck band (710), with the resulting reduced thickness of the neck band (710) at the cutout causing the increased flexibility.

Tension on the tension cable (722) may be increased by the listener pulling on a second end of the tension cable (722). The tension cable (722) may be routed from the attachment point (726) on the exterior of the U-shape of the neck band (710) via cable guides (724) to a central region of the neck band, where the second end of the tension cable (722) may be accessible for operation, as illustrated in FIGS. 7A and 7B. The neck band (710) may, thus, be loosened (thereby increasing the aperture (752A)) by pulling on the second end of the tension cable (722). The tension cable (722) may include features to facilitate pulling, e.g., a knot in the tension cable or a knob at the end of the tension cable. Two separate tension cables may be installed to operate both leg sections of the neck band, or alternatively a single tension cable may be installed. The single tension cable may connect to both attachment points (one on the left leg section of the neck band and one on the right leg section of the neck band), and the user may pull in a central region of the single tension cable to simultaneously apply tension on both sides of the neck band. If a single tension cable is used, the tension cable may form a loop at the back of the neck band, in the region of the curved base section of the U-shaped neck band. The loop may be grasped and pulled for loosening the neck band.

In one or more embodiments of the invention, locking clips (732) are provided to keep the tension cable (722) under tension, once tightened.

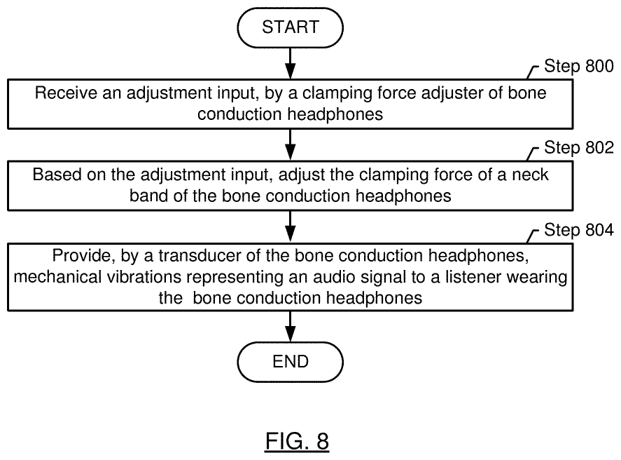

FIG. 8 shows a flowchart in accordance with one or more embodiments of the invention. While the various steps in these flowcharts are provided and described sequentially, one of ordinary skill will appreciate that some or all of the steps may be executed in different orders, may be combined or omitted, and some or all of the steps may be executed in parallel.

Turning to FIG. 8, in Step 800, a listener intending to use or currently using a bone conduction headphone is operating the clamping force adjuster to either tighten or loosen the bone conduction headphones. The clamping force adjuster may be configured as described with reference to, for example, FIGS. 3A, 3B, 3C, 4A, 4B, 5A, 5B, 5C, 6A, 6B, 7A, and 7B, and accordingly the operation of the clamping force adjuster may be performed as described with reference to these figures.

In Step 802, based on the operation of the clamping force adjuster, the clamping force of the neck band adjusts. The components involved in the adjustment and the execution of the adjustment of the clamping force depends on the configuration of the headphones as previously described with reference to FIGS. 3A, 3B, 3C, 4A, 4B, 5A, 5B, 5C, 6A, 6B, 7A, and 7B.

In Step 804, one or more transducers of the bone conduction headphones provide mechanical vibrations, representing an audio signal, to the listener wearing the bone conduction headphones. The mechanical vibrations may be transmitted, via the cranial bones to the inner ear of the listener, where the mechanical vibrations may be translated into a neural signal allowing the listener to perceive the audio signal. The quality and amplitude of the transmission may be affected by the level of clamping force. Generally speaking, a higher clamping force results in a better mechanical coupling of the transducers to the cranial bones, thus providing a higher amplitude and/or higher quality audio signal.

Those skilled in the art having benefit of the disclosure will appreciate that the steps described in FIG. 8 may be performed in different orders and/or the steps may be performed in parallel. For example, the transducers may already transmit prior to making an adjustment to the clamping force. Further, the listener may operate the clamping force adjuster while wearing the headphones or prior to wearing the headphones.

Various embodiments of the disclosure have one or more of the following properties. Unlike conventional non-adjustable bone conduction headphones, bone conduction headphones in accordance with one or more embodiments reduce or eliminate the tradeoff between wearing comfort and quality and/or amplitude of the audio signal provided to the listener wearing the bone conduction headphones. More specifically, bone conduction headphones in accordance with one or more embodiments may be tightened by the listener to provide a superior transmission of the audio signal and may be loosened to increase the wearing comfort, as desired. Embodiments disclosed herein may result in an increased versatility of bone conduction headphones and may qualify bone conduction headphones for applications that would otherwise not be feasible. For example, bone conduction headphones in accordance with one or more embodiments may be worn in situations that require a particularly tight fit, for example, during physical exercise, and/or when superior audio quality is a necessity while still allowing the same bone conduction headphones to be adjusted for wearing comfort.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. Bone conduction headphones, comprising:
a transducer configured to convert an electrically provided audio signal into mechanical vibrations;
a neck band comprising a curved base section and two leg sections extending from the curved base section, providing a substantially U-shaped space to accommodate a listener's head between the two leg sections,
wherein the transducer is disposed on the neck band at a distal end of one of the leg sections, and
wherein the neck band applies a clamping force on the listener's head, the clamping force establishing a mechanical interface for transmission of the mechanical vibrations from the transducer to a cranial bone of the listener's head; and
a clamping force adjuster enabling an adjustment of the clamping force of the neck band.

2. The bone conduction headphones of claim 1, wherein the clamping force adjuster comprises a removable stiffening brace installable on the neck band to increase the clamping force.

3. The bone conduction headphones of claim 2, wherein the removable stiffening brace is over-curved in comparison to the neck band, causing a decrease of an aperture of the substantially U-shaped space.

4. The bone conduction headphones of claim 2, wherein the removable stiffening brace increases a stiffness of the neck band.

5. The bone conduction headphones of claim 2, wherein the removable stiffening brace comprises a shell partially enclosing the neck band.

6. The bone conduction headphones of claim 1, wherein the clamping force adjuster comprises a tension cable causing an increase of the clamping force when pulled,
the tension cable comprising a first end affixed to the neck band on an interior of the U-shape, and a second end configured to be pulled by the listener,
wherein pulling the second end increases a curvature of the neck band causing a decrease of an aperture of the substantially U-shaped space.

7. The bone conduction headphones of claim 6,
wherein the neck band further comprises a cable passthrough for the tension cable.

8. The bone conduction headphones of claim 4, wherein the neck band comprises a cutout forming a pivot point configured to facilitate the increase of the curvature of the neck band.

9. The bone conduction headphones of claim 1,
wherein the neck band comprises:
a casing forming the curved base section; and
two sliding cores, disposed in the casing, the two sliding cores forming the two leg sections; and
wherein operation of the clamping force adjuster causes:
an increase of an aperture of the substantially U-shaped space when the two sliding cores slide into the casing, and
a decrease of the aperture of the substantially U-shaped space when the two sliding cores slide out of the casing.

10. The bone conduction headphones of claim 9, wherein the two sliding cores are at least partially curved.

11. The bone conduction headphones of claim 9, wherein the clamping force adjuster comprises a tension cable affixed to the two sliding cores, causing the sliding of the sliding cores into the casing when pulled by the listener.

12. The bone conduction headphones of claim 1,
wherein the neck band comprises two halves with an overlap at the curved base section of the U-shape, each half forming one of the two legs,
wherein operation of the clamping force adjuster causes:
an increase of an aperture of the substantially U-shaped space when the overlap of the two halves increases, and
a decrease of the aperture of the substantially U-shaped space when the overlap of the two halves decreases.

13. The bone conduction headphones of claim 12, wherein the clamping force adjuster comprises a rack and pinion gear to control the overlap of the two halves of the neck band.

14. The bone conduction headphones of claim 1, wherein the clamping force adjuster comprises a tension cable causing a decrease of the clamping force when pulled,
the tension cable comprising a first end affixed to the neck band on an exterior of the U-shape, and a second end configured to be pulled by the listener,
wherein pulling the second end decreases a curvature of the neck band causing an increase of an aperture of the substantially U-shaped space.

15. The bone conduction headphones of claim 14, wherein the neck band comprises a cutout forming a pivot point configured to facilitate the decrease of the curvature of the neck band.

16. A clamping force adjuster for bone conduction headphones, comprising:
a removable stiffening brace installable on a neck band of the bone conduction headphones to increase a clamping force applied on a listener's head by the neck band.

17. The clamping force adjuster of claim 16, wherein the removable stiffening brace is over-curved in comparison to the neck band to increase the clamping force.

18. The clamping force adjuster of claim 16, wherein the removable stiffening brace increases a stiffness of the neck band.

19. The clamping force adjuster of claim 16, wherein the removable stiffening brace comprises a shell partially enclosing the neck band.

20. A method for adjusting a fit of bone conduction headphones, comprising:
receiving, from a listener and by a clamping force adjuster of the bone conduction headphones, an adjustment input; and
based on the adjustment input, adjusting spring-like characteristics of a neckband of the bone conduction headphones to modulate a clamping force of the neck band,
wherein the neck band establishes a substantially U-shaped space to accommodate a head of the listener, the neck band applying the clamping force to the head to establish a mechanical interface for transmission of mechanical vibrations from a transducer of the bone conduction headphones to a cranial bone of the head.
